(19) United States
(12) Patent Application Publication
(10) Pub. No.: US 2023/0049160 A1
(43) Pub. Date: Feb. 16, 2023

(54) DYNAMICALLY UPDATING RESOURCE ALLOCATION TOOL

(71) Applicant: Salesforce, Inc., San Francisco, CA (US)

(72) Inventor: Michael McCormick, San Francisco, CA (US)

(73) Assignee: Salesforce, Inc., San Francisco, CA (US)

(21) Appl. No.: 17/875,599

(22) Filed: Jul. 28, 2022

Related U.S. Application Data
(60) Provisional application No. 63/232,306, filed on Aug. 12, 2021.

(51) Int. Cl. G06Q 10/06

(52) U.S. Cl. CPC G06Q 10/06313; G06Q 10/06316; G06Q 10/0635

(57) ABSTRACT

An allocator tool represents work items in project. Work items may have an associated ID, status, cross-reference to child tasks to be complete before a work item may be complete, a child status of what resource the child is assigned, a sequence ID to indicate in which order a resource is going to work on a work items, and an expectation of how long it will take to do each work item. A calendar aspect of the allocator tool may track when work items are to be performed. Calendar entries may employ formulas/logic/AI to determine whether or not on that date for that work item a resource will be working on a task. Calendar gaps (idle time) may be identified and work items rearranged or reassigned to minimize gaps. Artificial Intelligence may perform calendar gap identification and remediation.

### CROSS-REFERENCE TO RELATED APPLICATIONS

This application claims the benefit of U.S. Provisional Application No. 63/232,306, filed Aug. 12, 2021, which is hereby incorporated by reference.

### TECHNICAL FIELD

One or more implementations relate to the field of project management; and more specifically, to manual or Artificial Intelligence managed dynamic resource tracking, allocation and re-allocation to reduce operational gaps in performance of project tasks.

### BACKGROUND ART

Project management and resources allocation are complex tasks. Typical project planning tools provide a flat backlog of tasks that need to be performed. Consider a project to be a series of interconnected tasks that need to be completed to complete the project, where each task is a series of operations that need resources (tools, people, access, data, material, precedent-operations, time, etc.) to be performed to complete the task. Lack of insight into the relationships between resources means one cannot really visualize what resources are dependent on what other resources. It is difficult to determine what has to happen first in order to enable other operations to occur. It is particularly difficult to make more efficient the scheduling and use of multiple employees, tools, software, etc. (collectively resources) where the resources have various constraints. For example a resource may depend on other resource operations to complete before proceeding on a current operation, or resource availability (e.g., a tool may be busy working another project, an employee may be out on vacation, etc.).

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates an exemplary resource allocator tool according to some example implementations.

FIG. 1A illustrates the left portion of the FIG. 1 allocator tool,

FIG. 1B illustrates the right portion of the FIG. 1 allocator tool,

FIG. 2 illustrates an excerpt from the FIG. 1 right portion.

FIG. 3 illustrates an excerpt from an exemplary implementation of a spreadsheet-based allocator tool using overrides.

FIG. 4A illustrates an exemplary flowchart embodiment of a project for an assembly of a saltshaker that may be represented an allocator tool.

FIG. 4B illustrates an exemplary flowchart in accord with FIG. 4A.

FIG. 5A illustrates an exemplary mapping of story points to days of effort (time) in an allocator tool.

FIG. 5B illustrates an exemplary chart 520 calling out Assignees and Sequence values.

FIG. 5C illustrates an exemplary chart 530 illustrating task dependencies.

FIG. 5D illustrates charts corresponding to an allocator tool that may be analyzed to identify and close gaps (idle time).

FIG. 5E illustrates charts according to an exemplary implementation corresponding to an allocator tool that may be analyzed to identify and close gaps (idle time).

FIG. 6 illustrates exemplary instructions that may be embedded within a resource allocator tool to explain, briefly, how the tool may be used and manipulated to efficiently enter, track, and manage one or more work projects and associated work items.

FIG. 7 illustrates a flowchart for operation of an allocator tool according to an exemplary implementation.

FIG. 8A is a block diagram illustrating an electronic device according to some example implementations.

FIG. 8B is a block diagram of a deployment environment according to some example implementations.

### DETAILED DESCRIPTION

The following description describes implementations for providing a resource allocator that may be used to model a project and enable reorganizing project tasks and/or work items to minimize wasted resources, such as from idle resources. As will be discussed in more detail below, a network-aware and/or network-coupled computing platform may execute applications for one or more device, where the computing platform includes one or more application program to provide the resource allocator discussed herein.

It will be appreciated the term “execute” includes various techniques for making the application program available, including a processor performing operations stored in a file, as well as a computing platform providing an environment that may interpret instructions. For example, a computing platform may execute or otherwise make available a network application program such as a browser, which may be an “Internet” browser type of program that may evaluate/interpret/execute/etc. network accessible resources such as those written in markup languages such as Hypertext Markup Language (HTML), eXtensible Markup Language (XML), eXtensible Hypertext Markup Language (XHTML), etc., written in or combined with programming languages such as Java, JavaScript, Typescript, PHP, etc., or written in another language or application program data structure, e.g., a programming environment embedded within an application program, such as a spreadsheet application program. The computing platform may also provide and/or otherwise make available a network application program as a standalone application program that may communicate with other application programs and/or services or resources over a network.

It will be appreciated there are many different languages that may be used and these are just an exemplary few that are known to those skilled in the art. It will be appreciated in one embodiment, a device may refer to where a browser or other application program is being executed (and accessing remote network resources, servers, etc.), and there may be one or more user of the device that interacts with the device to generate, e.g., operations, commands and/or user interface activity. It will be appreciated a device need not have a local user operating it, and that the device may be under operation from another source or location, such as a remote user, remote access (e.g., VPN), virtual terminal, etc. It will also be appreciated the device may be self-directed such as by way of an Artificial Intelligence, Expert System, or other autonomous action system.

It will be appreciated any project may be broken into one or more task, and a task may be broken down into a sequence of operations needed to perform the task, where each operation may require access to and results from one or more resources. Each operation may have an associated estimation of a required sequence of operations, the time to perform an operation, and a constraint to what extent, if any, parallelization may be employed to overlap performance of an operation. And, as may often occur, operations may stall or otherwise be blocked awaiting performance of a related operation that must be performed before another may be performed. If one can visualize tasks associated with a project, one can see gaps in an existing workflow where one or more resource may be stuck waiting on a deliverable from another resource (e.g., output from a person, machine, software, data source, tool, etc.). This makes harder answering simple questions such as when will a project complete. Note terms such as “visualize”, “see”, and the like are used herein, and while they may refer to a person looking an output, display, or other information associated with a resource, e.g. a machine, an application program and/or output thereof running on a machine, etc. these terms are intended to include automated review and/or analysis by a machine, such as an Artificial Intelligence (AI) directed to “visualize”, “see”, etc. characteristics of a project, process, task, etc. and take action, such as to reconfigure a project configuration in in an allocator tool, to reconfigure operation of a machine, update/change/interact with an application running on a machine, or take other action as needed.

A project's tasks may have associated “story points” which may roughly the number of time units, e.g., minutes, hours, days, weeks, etc. associated with a task, as well as a velocity of a resource that measures a resource's general availability, such that a 50% velocity translates to taking twice as many story points (e.g., more time than usual). For example, if we assume velocity is a linear adjustment to time to complete a task, then a 1 day task may take 2 days at 50% velocity. It will be appreciated velocity is not necessarily linear and a slippage concept may be used that accommodates elasticity in velocity, e.g., the velocity may be interpreted as an approximation of completion time. Slippage may track project and/or task completion time running over an expectation, but it may also include project and/or task completions completing earlier than expected. Even with such measures available, ultimately one cannot rely on story points because other variables may interfere with efficiently delivering/performing tasks associated with a project.

To make project planning more closely reflect reality, in various exemplary implementations, we track as accurately as possible (in a “resource allocator” tool discussed below) what each resource (e.g., people, machines, etc.) is tasked to work on, in what order the tasks are occurring, and how long each task is to take—and then close gaps in a tool's schedule to remove as much as possible any idle time introduced due to inefficient scheduling of tasks to resources. In one exemplary implementation, a goal is to get calendar time as close to effort time as is possible, which means less idle time for resources, and more predictable delivery of project deliverables to relevant stakeholders. When performed consistently (e.g., by way of automated AI analysis), constantly and iteratively, one may get early predictions of project performance to goals for tasks happening now and in future. If a project, or just a task, appears to go off track, it may impact your ability to deliver in the future. This may be alleviated if (automated or manual) task assignment adjustments are regularly performed.

It will be appreciated an AI, machine learning, or other reasoning system, may be communicatively coupled with a variety of information sources, including a machine providing the resource. It will be appreciated the AI may be a combination of one or more machine learning systems, e.g., a neural network, deep neural network, convolutional neural network, “deep learning” or other type of reasoning system that may be used to provide input to one or more participants in a conference. Exemplary deep learning AIs include Convolutional Neural Network (CNN), K-nearest neighbor (KNN), Artificial Neural Network (ANN), Recurrent Neural Network (RNN), Deep Neural Network (DNN), Deep Belief Networks (DBN), as well as many others. It will be understood the AI may learn and/or train from supervised and unsupervised learning approaches so as to more effectively identify and reduce gaps present in a resource allocator's model for a project (or projects). Supervised training may include the AI monitoring a person manipulating the tool to remove gaps, as well as providing the AI with examples of “good” and “bad” spreadsheet configurations, such that the AI may learn adjustments that represent desirable outcomes.

In the context of the foregoing, the following illustrated exemplary implementation are presented.

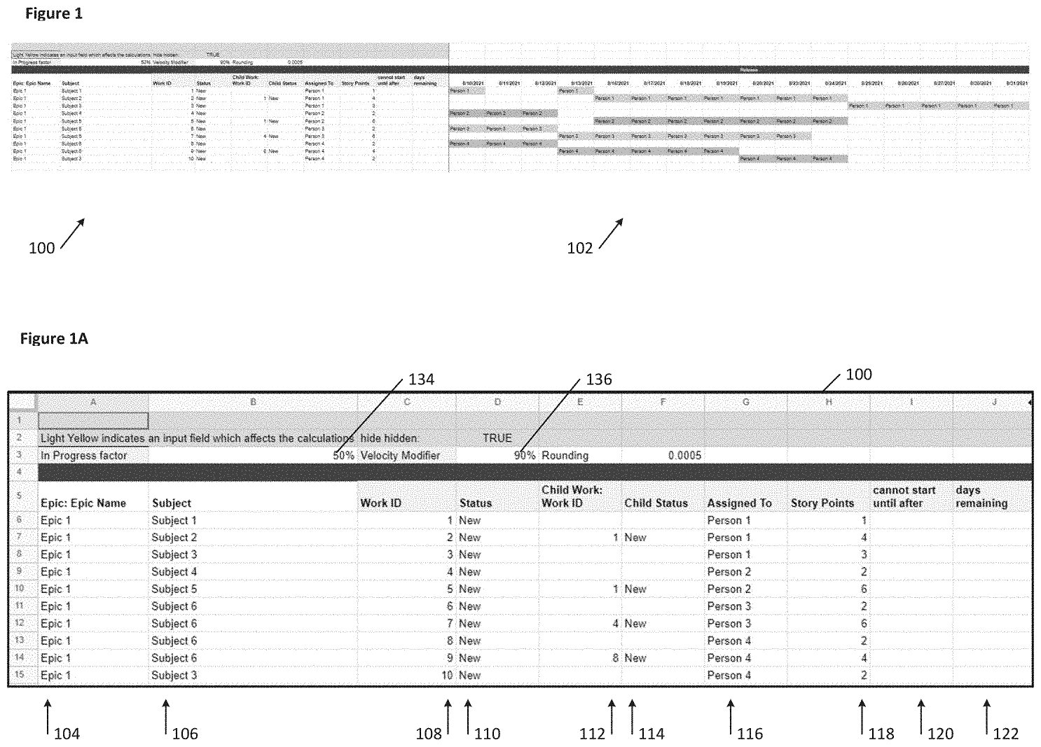

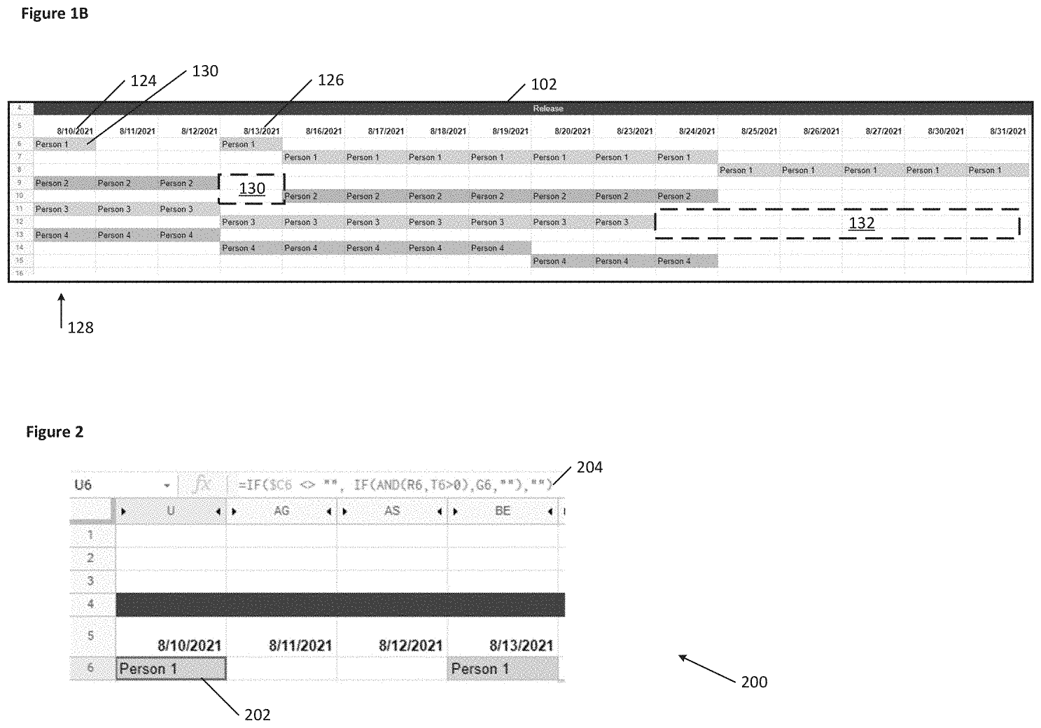

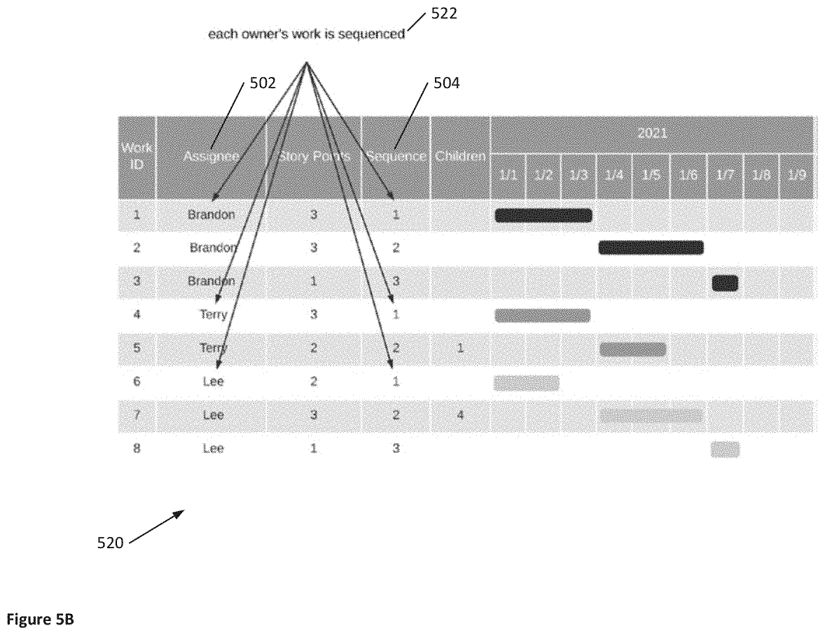

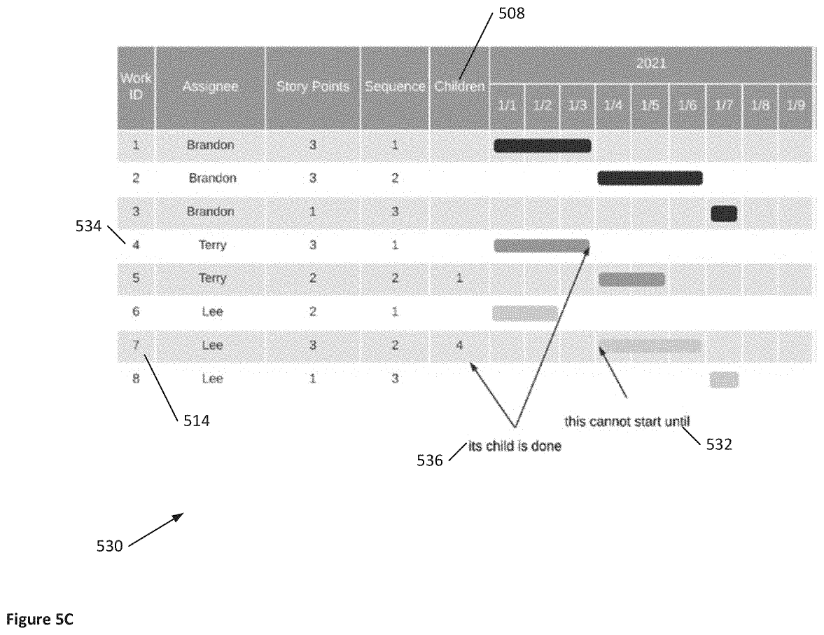

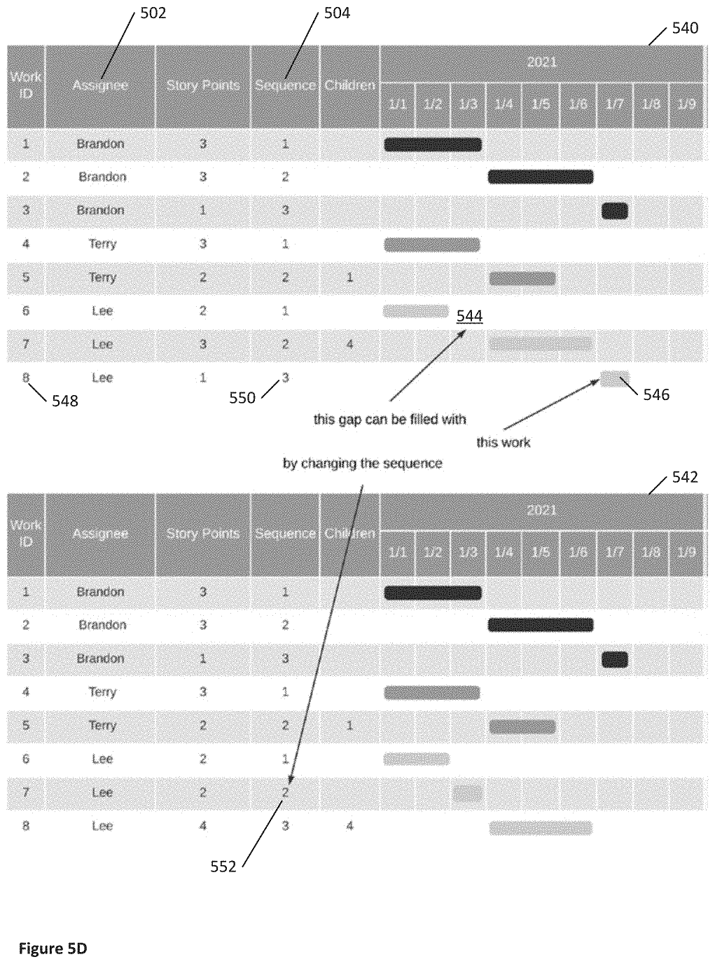

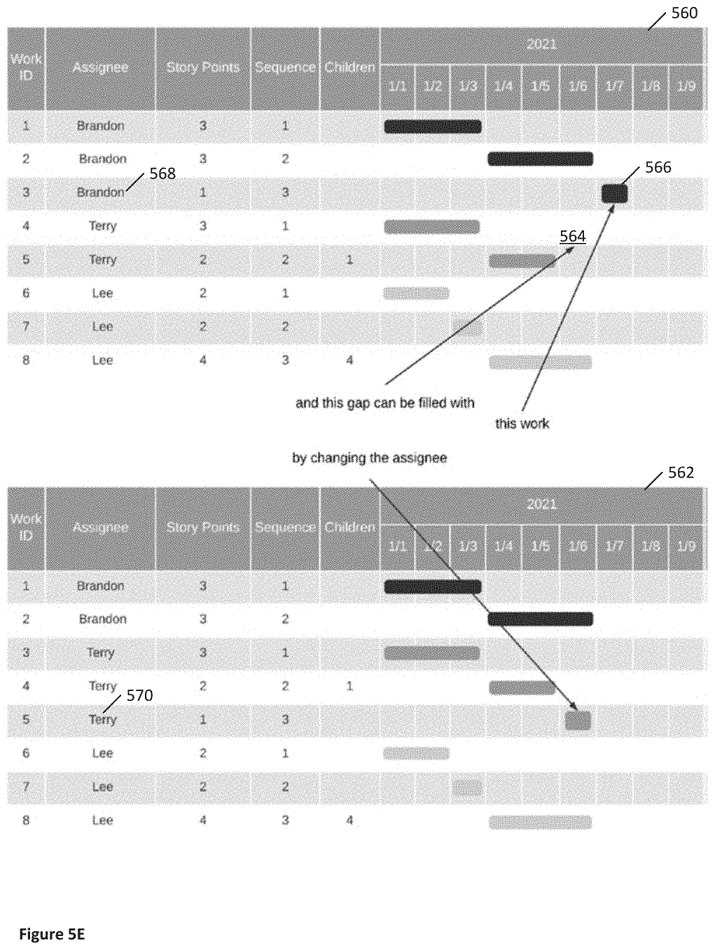

FIG. 1 illustrates an exemplary resource allocator tool that has been implemented, for expository convenience, in a spreadsheet such as may be hosted within a Google Sheets document, Microsoft Excel document, or the like, as well as in other tools, software, execution constructs, etc. As illustrated the tool has two main visible portions, a left portion 100 indicating work items/tasks, and a right portion 102 indicating a calendar, in which each line in the spreadsheet (e.g., rows 6-15) represents a work item, e.g., a task to be performed, where a task may itself represent multiple operations to be performed. (See also FIG. 5 discussion.) For convenience, a task will be assumed to correspond to a single operation to be performed.

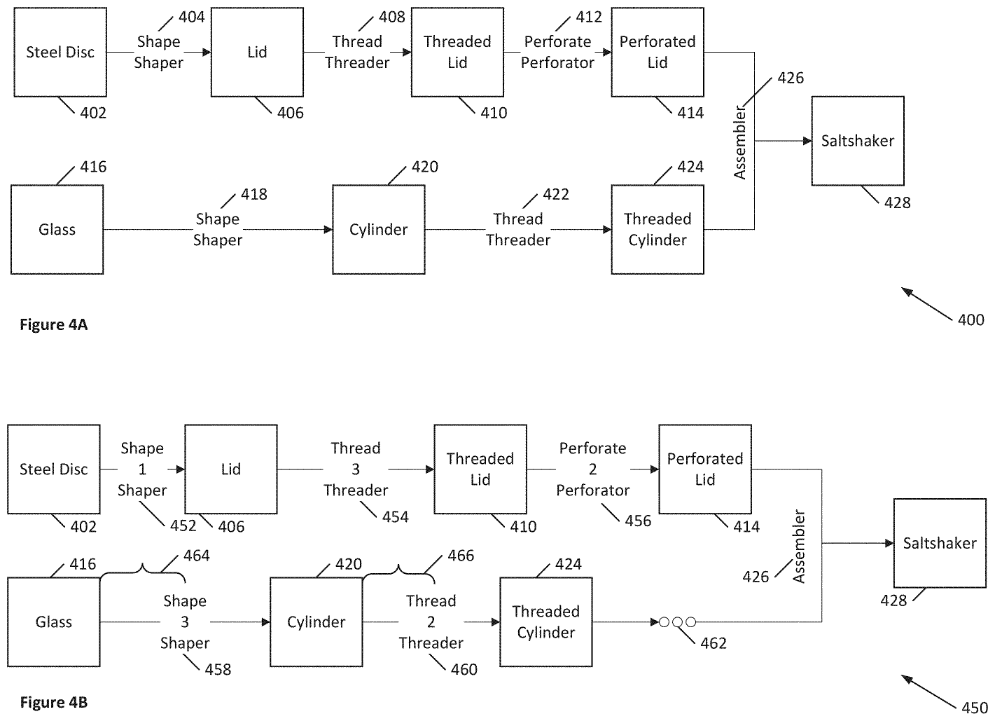

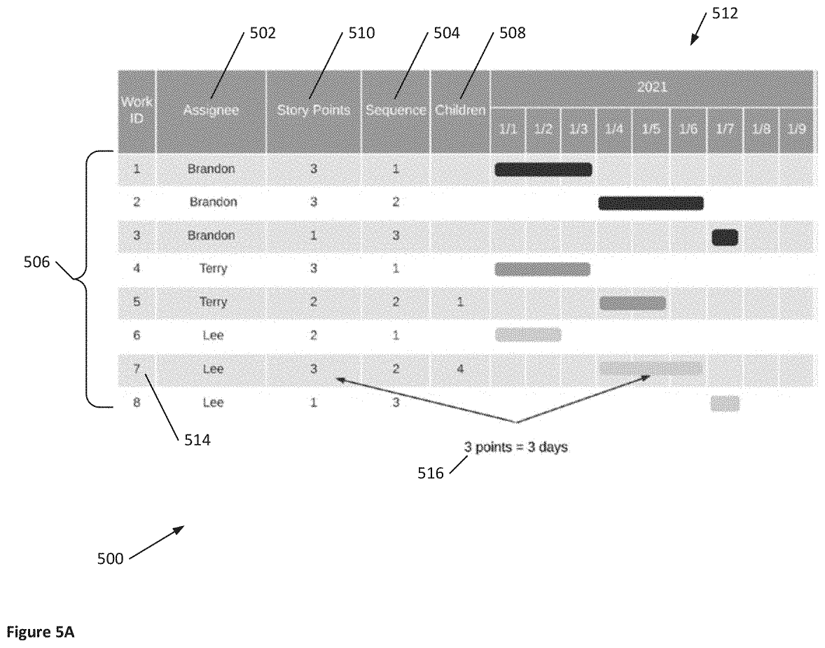

To facilitate discussion of the allocator tool, assume a project concerns creating and assembling components of a saltshaker, e.g., identifying the component parts of the saltshaker, determining what needs to be created or procured to build the component parts, determine in what order to make and/or assemble the component parts, etc. It will be appreciated there are multiple operation sequences that need to be performed in order to build, for example, the lid and base of a saltshaker (see, e.g., FIG. 4A), and that various constraints (see, e.g., FIG. 4B) prevent a straightforward application of the resources to create a saltshaker since, for example, some tools may be unable to simultaneously perform multiple jobs and hence one operation will stall and wait on completion of another. It will be appreciated various actions may be taken to adjust the allocator tool to improve production.

FIG. 1A illustrates the left portion of the FIG. 1 allocator tool in more detail. Each work item belongs to a project with an Epic Name reference 104 (e.g., in the exemplary illustration each work item belongs to the “Epic 1” project), and it may have a Subject 106 description. The work items also have an associated ID 108 to track that work item represented by the row in the spreadsheet, the status of the work item, e.g., is it “New” or “In progress” (status may be used, in some implementations, as discussed below, to adjust how timing expectations are made, e.g., in progress tasks may be assumed to perform more quickly than new tasks that may need to spin up. Also illustrated is a Child Work: Work ID 112. This column identifies work items that have to be completed before the work item represented by the row with corresponding Work ID (e.g., column 108) may be considered complete. This is one exemplary implementation of tracking dependencies between work items represented in the allocator tool. The tool portion 100 may also identify the status of the children 114 (e.g., is this a New dependent task, in process, etc.), and to whom the work item is assigned 116 and in which order that person is going to work on the work items, as well as a story points metric (e.g., how much time) is allocated 118 (expected) for completing the task. There are also columns for tracking impediments to starting a task that will be discussed further below, such as a “cannot start until after” date 120, and “days remaining” column 122 that will be discussed further below.

In one exemplary implementation, a resource allocator tool for tracking tasks associated with the saltshaker project may be implemented or otherwise performed with a dependency tree, data structure, spreadsheet, or other structure capable of tracking interdependencies between sequences of operations related to a project. For example, creating the saltshaker may have an associated workflow for the project tracking projects, resources (e.g., people or other resources). In particular, children 114 attributes may be used to at least in part identify and enforce sequencing of work, e.g., to ensure operations required to complete various tasks are performed in a correct/required dependency order. When a project is planned out in a resource allocator as will be discussed further below, one may then start looking for ways to make it more efficient. When one needs to schedule a project, it is helpful to be able to visualize what operation needs to happen before another operation. With a visual presentation in a resource allocator, one may see gaps where one resource is stuck waiting on another. This facilitates planning optimization to remove gaps or other delays that may undesirably push out delivery dates, as well as waste costs on having idle resources.

To alleviate and/or minimize lost time and wasted resources, in various exemplary implementations, gaps in project representation in a resource allocator are identified and, where possible, removed. Various resources (which may be people, machines, data, etc.) may be tracked and presented in a resource allocator and assigned to various tasks/operations. Gaps in the resources (employee downtime, tool unavailability, data unavailability or staleness, etc.) may be identified, e.g., visually highlighted (e.g., for a person's review) or otherwise called out (e.g., to facilitate Artificial Intelligence (AI) review). Rather than leave gaps, instead the association of tasks to resources may be reorganized so long as they do not violate a dependency between the tasks and/or operations making up a task. Reorganization of tasks allows shuffling resources and tasks such that gaps may be reduced if not eliminated. It will be appreciated phrases such as “visual presentation” and terms such as “highlighted”, as noted above, are intended to be used in multiple ways. For example, one is in the literal sense, e.g., to facilitate a person to see gaps in resource allocation that may be optimized as disclosed. However, it will be appreciated AI may be employed to analyze a resource allocator to identify gaps, and terms and phrases relating to viewing, inspecting, etc. an allocator tool are intended to accommodate data being reviewed by an AI, heuristics, or other analysis construct to identify different possible reconfigurations of a resource allocator tool so as to improve a project's efficiency, e.g., to reduce a project's time, costs, etc.

FIG. 1B illustrates the right portion of the FIG. 1 allocator tool, which includes a calendar 102 incrementing by day into the future. It will be appreciated past projects may be presented but for presentation clarity the calendar represents future dates. In the illustrated implementation, for example, item 124 indicates Person 1 will be working on the work item represented by row 6 of the spreadsheet on Aug. 10, 2021 and then not working on that project again (due to some dependency/constraint blocking work) until Aug. 13, 2021 as indicated by item 126. Item 128 indicates that on Aug. 10, 2021, Persons 1-4 are working on different work items on that day. In one exemplary implementation, each of the calendar cells may have a special set of algorithms or formulas that automatically recalculate as changes are made within the allocator tool. For example, moving a row will adjust the order in which a task or process may be performed and that movement will trigger, for example, an adjustment to the dependencies between tasks and that in turn may result in a change to, for example, the end date for a project. Adjustment to a project's end date may occur, for example, if a task was blocked due to dependencies in the allocator tool, but the dependencies were minimized or removed with movement of a task to a different location (e.g., to a different task assignee or different sequence position in the tasks to be performed).

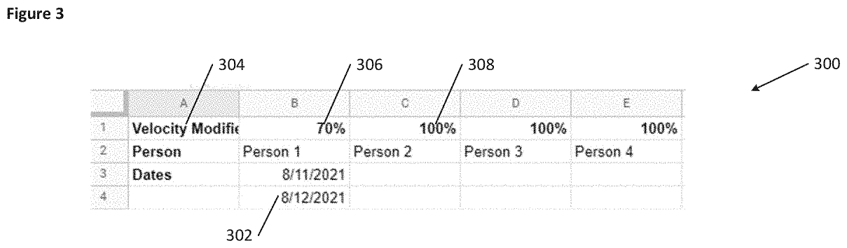

FIG. 2 illustrates an excerpt 200 from the FIG. 1 right portion 102 according to an exemplary implementation, in which FIG. 1B item 130 referring to Person 1 has been selected at item 202, and the selection reveals an exemplary formula 204 that may be used to evaluate whether or not, on the selected date for that work item, whether a resource, e.g., a person, tool, etc. will be working on the work item represented by the row of the spreadsheet. Returning to FIG. 1A, we can see the work item represented by row 6 of the spreadsheet tool is assigned to Person 1 and will be working on it for 1 day (assuming story points are set 1:1 with days and not adjusted (see, e.g., the FIG. 3 discussion). As shown in row 7, Person 1 is also working on a child task that will take 4 days and it needs to be completed as indicated in column 112 before the row 6 Work ID 1 work item can be completed. As shown in row 8 Person 1 is also working on another work item that is expected to take 3 days. In total Person 1 has 8 days of work to perform. See also row 10 Work ID 5 is another child task that must be completed before Work ID 1 may complete. In such manner various projects may be defined with multiple work items or tasks that need to be performed and dependency relations between the tasks (as discussed above with respect to building a saltshaker) may be preserved to ensure proper in-order completion of work items associated with a project.

Assume the work items shown in the left portion 100 of the spreadsheet, rows 6-15, correspond to a product with a desired completion date of Aug. 20, 2021. Looking at the right half 102 of the spreadsheet, we can see the last work item to be completed will be by Person 1 on Aug. 31, 2021, well past the desired completion date. However, we can also see there are gaps 130, 132, as well as others not called out. For example, Person 3 is idle for 6 days (from the 24th through the 31st) as indicated by item 132. When there are gaps in the spreadsheet, a review of the task dependencies will show that a resource is blocked waiting on completion of a dependent child work item. Rather than allowing a resource to remain idle waiting, instead in various implementations, the assignment of work items may be moved around to remove the limitation, e.g., by re-assigning a work item from one resource to another. In the exemplary illustrated spreadsheet it is assumed one may drag work items/cells to other locations in the spreadsheet so that work items may be reassigned to different resources (e.g., to different people, machines, shops, etc.) and the spreadsheet may automatically update workloads and expected completion dates. As noted above the gaps may be handled manually by a person visually identifying gaps and reassigning responsibilities to minimize gaps and/or an AI may assist with and/or perform reassignment of responsibilities between resources. By rearranging responsibilities it is possible in this example to, for example, remove all gaps, and with no gaps, what looked like a late release date on the 31st can be brought in to a gap-free timeline of an on-time release on the 20th.

When adding entries to the spreadsheet, e.g., in the left portion 100 of the exemplary spreadsheet-based allocator tool, one may sort by task assignee. Note the term “task” and the phrase “work item” are used largely interchangeably herein, as each may represent a context of actions or activity to be performed. As each line of the spreadsheet is a work item, sorting groups all activity for a particular resource shows all work to be performed currently and scheduled into the future for that resource. Each spreadsheet row is a work item plus the dependency “child” or “children” tasks/work items (referenced above) that must finish a parent work items may be deemed complete. If a work item has multiple children, the allocator tool calculates an estimated time of completion as the time estimated for the parent task plus the times for all of the children tasks, treating the parent plus children tasks as a single work item, which in effect it is. It will be appreciated, depending on the child task to be performed, child tasks may operate contemporaneously with and/or in parallel to the “parent” work item. However, if movement forward in the parent task requires completion of the child task, e.g., the child task is to produce a material needed in an operation performed by the parent task, then the parent task blocks and waits. While this may result in a gap in activity for the resource working on the parent task, as discussed above, gap filling may be used to rearrange, as desired, task assignments to allow an affected parent task resource to engage in a different task/work item while waiting on a child task.

In one exemplary implementation, the “cannot start until after” column 118 may be used to track, for example, external dependencies, such as waiting on output from a 3rd party vendor, results from a different organizational unit, etc. Such an indicator may result in a gap in processing the relevant work item (e.g., the row in which column 118 has an entry), and this gap may be addressed as discussed above. It may also be that a resource in question for the relevant task is busy, such as a person being out of town for a work meeting or conference, vacation, unexpected employment termination, etc. A delay may be treated as a “cannot start until after” limitation and addressed as other gaps have been, where tasks/work items may be reorganized and/or reassigned to allow available resources (other people, machines, etc.) to be tasked with some or all of the work items impacted by the delayed start to remove a delay/gap.

FIG. 3 illustrates an excerpt 300 from an exemplary implementation of a spreadsheet-based allocator tool using overrides (e.g., item 302) that may be entered for resources (in this case the Person 1 resource). Similar to the column 118 restriction on task assignment/processing, overrides may allow tracking, for example, Person 1 taking paid time off, for example, on Aug. 11, 2021 and Aug. 12, 2021. The resource allocator tool will automatically recalculate, treating these blocked dates as gating events that make a resource wait, e.g., treating as creating gaps to be reviewed for optimization to remove the block. Also illustrated is a Velocity Modifier 304, which may be used to adjust delivery speed on a work item/operation within a work item. For example, let us assume Person 1 is a technical lead, manager, or other role that has responsibilities that impact actual workday availability. For example, if Person 1 typically spends 50% of the day handing these other responsibilities, this of course will impact Person 1's ability to work on assigned tasks. To track this, the spreadsheet may associate a performance modifier 306, e.g., in the exemplary illustrated embodiment it is indicated Person 1 is operating at 70% efficiency. This means that at the end of a given day, 70% of the expected work output for that day (e.g., a story count of 1) will be accomplished in about 1.3 days. Compare this with Person 2 where this resource, as indicated by item 308, has no current restrictions/limitations, and is operating at 100% velocity.

Returning to FIG. 1A, in the illustrated exemplary implementation, the Status column 110 may be used to allow the resource allocator to refine completion estimates. When a project is new, it is expected that all of the expected days required will be utilized to complete the project (see, e.g., Story Points column 118). However, as work progresses (e.g., the task shifts from a “New” status to “In Progress”, it will be appreciated efficiency and progress to completion goals may be adjusted. For example, on average there may be a 50% (see, e.g., item 134) reduction in time required for an in progress work item. This value may of course be adjusted based on actual experience with progress-to-goals on a particular project and/or work item. And, while illustrated is a single factor (item 134), it will be appreciated other implementations may have multiple factors associated with different work items, types of work items, different resource/employee statuses (e.g., new employee, experienced, etc.). Also illustrated in the exemplary implementation is a Velocity Modifier (see, e.g., item 136).

It will be appreciated, over time, trends may be determined that indicate members of are a little more or a little less busy on average. In total, we can apply the same sort of scaling factor for personal efficiency to the team. For example, if the team is seeming to only be 90% effective in performing their tasks (as indicated by item 136), this may be reflected in the velocity modifier and used to track and therefore better estimate actual completion dates. It will be appreciated there may be multiple different teams working on different projects, and they may all be represented in an allocator tool such as the FIG. 1 spreadsheet. And as with interdependent parent/child tasks, team projects may also be linked into dependencies where the output from one team's project is entered as the dependent child project of a different team. In such fashion, different projects may be chained and coordinated to ensure completion of projects in a correct and efficient order. The relations between projects may show gaps that result in conversations between, for example, team leads, to allow reorganizing one or more projects to reduce or eliminate the gaps.

FIG. 4A illustrates an exemplary flowchart embodiment of a project for an assembly of a saltshaker that may be represented an allocator tool, such as discussed with respect to FIGS. 1, 2 and 5. In the physical world, if manually performing operations, the order of operations is typically clear. Assuming a salt-shaker contains two basic components, a base and a lid, even though some components may be created in parallel and/or one before other, fundament construction constraints exist, e.g., a completed saltshaker has basic requirements such as a lid cannot be used without creation of a base on which to place the lid. While some components may be built in parallel, a completed project needs all components to exist. To make process dependencies more clear, let us describe a saltshaker project as requiring a base to hold salt, with a lid with holes in it through which salt is poured. In further detail, the base is to be hollow, it may be transparent, and it may have ridges or texture to ensure a secure grip while shaking. The top is threaded (or otherwise designed to attach to the base) to secure a removable lid.

In the exemplary illustrated process for assembling a saltshaker, there may be two separate processes for creating the saltshaker, namely, determining a saltshaker lid, and determining a saltshaker base, both of which may be combined into a completed saltshaker. For the lid, one operation may be to obtain a steel disc 402, which may be shaped 404 by a shaper into a lid 406. The lid may then be processed by a threader 408 to define a threaded lid 410, which may then be perforated 412 by a perforator to define a perforated lid 414. In the other process, for the base, an operation may be to obtain glass 416 material for the base, which may be shaped 418 to determine a glass cylinder 420, which may then be threaded 422 to determine a threaded cylinder 424 for the saltshaker base. A completed saltshaker 428 may be determined by assembling 426 a completed lid 414 with a completed base 414 with an assembler tool. It will be appreciated this is a significantly simplified description of the process of creating a saltshaker. In addition it will be appreciated, separate from any timing constraints inherent to resource unavailability, e.g., tools and/or workers being unavailable, different ones of the operations 404, 408, 412, 418, 422 inherently may take different amounts of times to perform. In this illustrated embodiment, time to perform the tasks are suggested by the different lengths of lines for each operations, e.g., a longer line corresponds to a longer time required to perform the operation.

FIG. 4B illustrates an exemplary flowchart 450 in accord with FIG. 4A. As illustrated, the saltshaker project components 402, 406, 410, 414, 416, 420, 424, 428 remain the same. However in this embodiment, the operations between the process components are annotated with units of time to indicate how many units of time are (at least roughly) needed to perform the indicated process operation. Thus, shaping the steel disc 402 into the lid 406 takes one time unit 452, threading the lid with the threader takes 3 time units 454, perforating the lid takes two time units 456, shaping the glass 416 into the cylinder 420 with a shaper takes 3 time units 458, and threading the cylinder takes 2 time units 460.

Every tool takes a certain amount of time to do its work—to transform an object from one state to another. And some states take a tool longer to transform than others. Assuming in this illustrated embodiment one time unit corresponds to a minute, in these exemplary FIG. 4 embodiments, threading a glass cylinder takes two minutes, while threading a steel disc takes three. Based on this, how long does it take to build our saltshaker? According to FIG. 4B, the longest time is spent making the lid, e.g. at least 6 minutes (cumulative time for items 452, 454, 456). It will be appreciated the process configuration is inefficient in that the base takes 5 minutes (cumulative time for items 458, 460) and hence the base process idles 462 until the lid is complete at item 456. As discussed above with respect to FIG. 1 and FIG. 2, the saltshaker project build and the relationship between task or process operations and workers performing operations may be represented in the resource allocator tool. The process gap 462 is something that may be reviewed to determine if the gap may be avoided by rearranging operations to remove idle time.

Note we have not focused on whether work on the lid may or may not occur in parallel without regard to multiple uses of a tool, e.g., we did not discuss whether for example if the shaper operations 452, 458 may operate in parallel. In many situations, there is only one resource, e.g., a single specialized tool, so if the lid shaper operation 452 starts first, this would block starting the base shaper operation 458; the block would cause, at least for this conflict, the base process to idle for a minute 464 while the blocking lid shaper operation completes, i.e., the base shaper operation 458 may now take 4 minutes. To make the saltshaker project more efficient, we can look to various process operations and see, based on satisfying process dependencies (if any), whether operations may be performed in another order. For example, the base process initially idles 464 for one minute while waiting for the lid shaper operation. Can this initial idling be removed while satisfying process sequencing dependencies, such as cylinder shaping occurs before cylinder threading, lid shaping must occur before performing either perforating or threading, etc.?

Some operations may be switched around. For example, the lid may be perforated before threading, and the lid may be threaded before perforating. However, if we rearrange the process order, and for example, switch the order of threading 454 and perforating 456 the lid, this which removes idle time 466 from the overlap between lid threading 454 and cylinder threading 460 (which as illustrated now takes 3 minutes due to idling). There is no longer a simultaneous need for the threader. While this does not shorten the time required for the lid process, it does reduce the base process time requirement by eliminating the second idle time 466. Assuming the second overlap is a minute, then reordering the lid operations cuts that minute off of base processing. Thus, not including the assembly operation 426 common to both the lid and base processes, timing for the lid process would be 1 time unit (minute) for shaping the lid, 3 time units for threading the lid, and 2 time units for perforating the lid (6 time units), and timing for the base process would be 1 idle time unit, 3 time units for shaping the base, and 2 time units for threading the base (also 6 units total). Other process variations may be tried but they increase one or both lid and base processing times.

Note that in various embodiments risk management may be employed. For example, different operations, such as lid perforation and lid threading may have different associated risk of failure. Thus, if perforation happened to be a more risk of failure concern, then the perforation operation may be queued up sooner than later to ensure that a failure, were it to occur, happens earlier in the process to allow for remediation of the problem. Project planning may pad expected time units to perform a task with allowances for failure times and include, for example, time required to retool/reconfigure equipment to recover from an error or failure or the like.

FIG. 5 present one exemplary variation of the FIG. 1 embodiments in which a process may be represented in an allocator tool and gaps and/or inefficiencies and/or problems with a process may be addressed by way of manipulation and/or reorganization of allocator tool content to, for example, remove gaps in a project's process. FIG. 5A illustrates an exemplary mapping 500 of story points to days of effort (time) in an allocator tool. The illustrated tool is on a Gantt type of chart and the reader is assumed to be familiar with such charts. It will be appreciated the chart is for reader appreciation and in other embodiments a data structure may be used to encode the content of the illustrated chart in another functionally equivalent structure.

In this embodiment, there are at least two variables changing at the same time, an Assignee 502 (this could be a tool, person, software, etc.) to perform a task (e.g., in the FIG. 4 saltshaker project), and a Sequence 504, which represents the order in which any non-dependent tasks would be executed. Generally speaking, a task may have one or more characteristics such as discrete, sequenceable, single-owner, deliverable, reviewable, low-risk, and available to a process. For example, recall the saltshaker project where the lid thread and perforate tasks could happen in either order; these are tasks that satisfy all of the listed characteristics desirable for a task. As discussed above, tasks may have a Dependency, e.g., another task, event, status, etc. that must occur before the task may proceed, and a Size, e.g., an expected amount of effort required to complete the task. It will be appreciated it may be unclear where to start populating a chart with data. One approach is to simply assert a starting point for variables we can control, such as who gets which task, visualize results, and adjust the inputs, e.g., manually/interactively and/or by way of Artificial Intelligence (AI) analysis analyze the chart 500 (or other data structure encoding the process/tasks) for improvement(s).

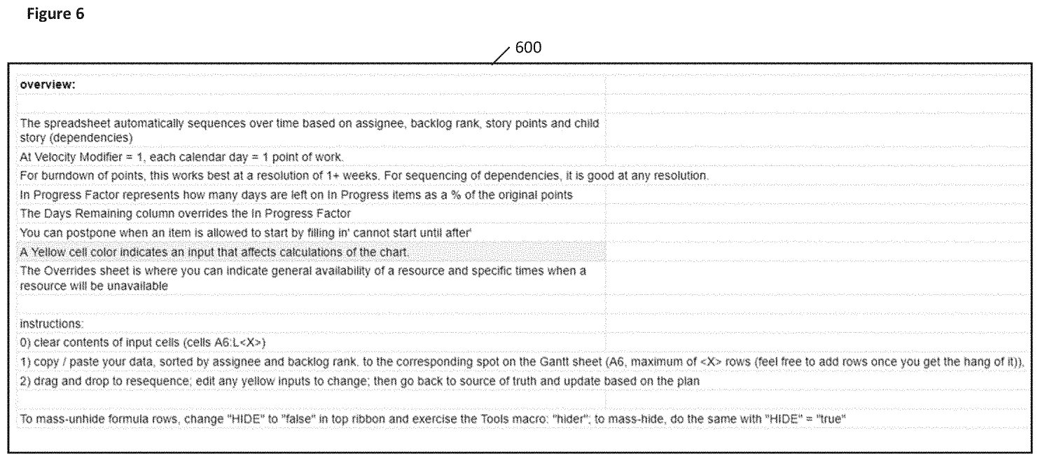

As discussed with respect to the FIG. 1 exemplary implementation, in this embodiment, tasks to perform (such as illustrated in FIG. 4) are represented by rows 506 of chart 500, and there may be cross-references 508 to child User Stories (projects, goals, tasks, to-do items, etc.) to be performed/achieved, Story Points 510 to indicate the expected number of time units (e.g. minutes, hours, days, etc.) to perform a task, a mapping to a calendar 512 showing time allocated and unallocated (idle time) for Assignees 502. As a chart is filled in, we can visualize when each task 506 will start, how long 510 it will take to complete, and who or what 502 will work on it. Logic (see FIG. 6) associated with the chart will apply dependency formulas to ensure, for example, no parent will start before its children tasks are complete (see FIG. 5C). Thus for example, in chart 500, Work ID 7 514 has 3 associated story points 510 and assuming in this chart 1 point represents 1 day of work to complete then 3 points represents 3 days of work 516.

FIG. 5B illustrates an exemplary chart 520 calling out Assignees 502 and Sequence 504 values. This chart reflects a current sequencing 522 of work for each Assignee, e.g., it indicates the ordering od tasks to be performed by a resource. A resource may be a tool, person, software, Artificial Intelligence, access or remote data, etc. FIG. 5C illustrates an exemplary chart 530 illustrating task dependencies. As illustrated, Work Item 7 514 shows a related child task (in Children 508 column), which means a task starting on 1/4 cannot start 532 until the dependent child task on Work ID 4 534 is done 536.

FIG. 5D illustrates charts 540, 542 according to an exemplary implementation corresponding to an allocator tool that may be analyzed to identify and close gaps (idle time). In one embodiment, a gap represents a resource that is idle while waiting for a dependent User Story to be completed, e.g., a task, process, project, etc. It will be appreciated a User Story may be a simple task to perform, another project to complete, and/or an arbitrarily complex nesting of another allocator tool(s) within the illustrated allocator tool charts 540, 542. When there is a gap 544, the gap may be filled by readjusting the allocator tool entries in the chart 540 to close it, such as by either shuffling the assignment of the User Stories or by changing the sequence an assignee is working on their User Stories. For example the gap may be closed by filling it with work 546 from Work ID 8 548 by changing the Sequence 504 of the Assignee's 502 assigned task from sequence 3 550 to 2 552. FIG. 5E illustrates charts 560, 562

FIG. 5E illustrates charts 560, 562 corresponding to an allocator tool that may be analyzed to identify and close gaps (idle time). In one embodiment, gaps may be closed, e.g., gap 554, by filling it with work assigned to another Assignee. For example, task 566 may be reassigned from “Brandon” 568 to “Terry” 570 and the tool updated to reflect that the gap has been closed. In such fashion a project may be periodically and/or continuously reviewed and updated to minimize or remove any gaps in the project by reordering and/or reassigning tasks between resources. In some embodiments, the time allocated to a task may have an associated multiplier (not illustrated) representing whether a resource is performing faster or slower than anticipated.

FIG. 6 illustrates exemplary instructions 400 that may be embedded within a resource allocator tool to explain, briefly, how the tool may be used and manipulated to efficiently enter, track, and manage one or more work projects and associated work items. And thus, based on the discussion of the FIGS. 1-5 exemplary implementations, it will be appreciated various implementations of an allocator tool may represent work items in a data construct, such as lines in a spreadsheet-based tool. It will be appreciated the spreadsheet context is used for discussion clarity, as spreadsheets are well-known, but the data and logic associated with an allocator tool may, of course, be represented by any other data structure.

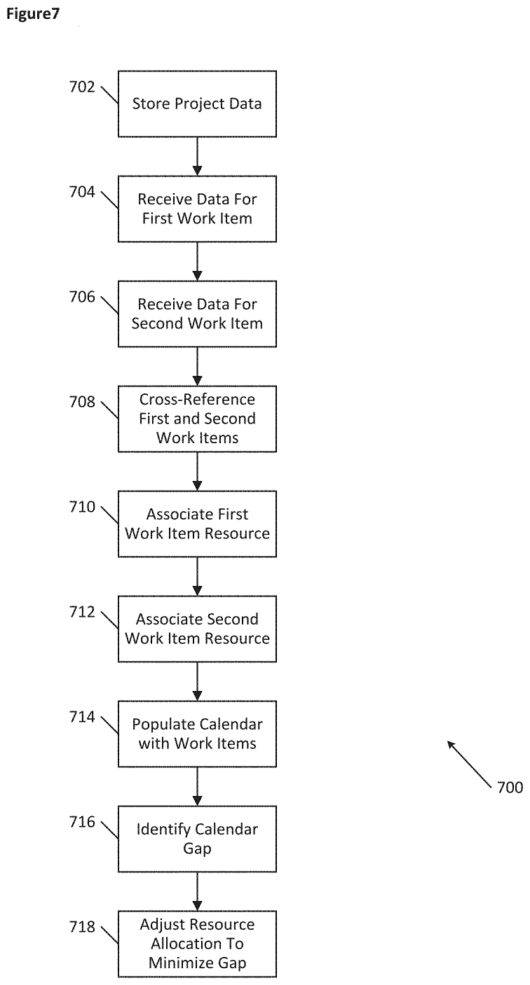

FIG. 7 illustrates a flowchart 700 for operation of an allocator tool according to an exemplary implementation. In the illustrated embodiment a resource allocator, e.g., an allocator tool which as discussed above may be practiced as a spreadsheet or other data structure/program environment, may store 702 data corresponding to a project having associated work items, in which as discussed above, work items may have associated therewith an ID to uniquely identify the associated work item, a child ID to cross-reference to a different work item, a resource to perform the work item, and a story points metric to estimate time to complete the work item. The allocator tool may track many work items or tasks or the like for the project. The allocator may receive 704 data corresponding to a first work item, where the first data may include a first ID, and a first story points metric. The allocator may also receive 706 data corresponding to a second work item, where like the first data, the second data may include a second ID, and a second story points metric.

If there is a dependency between the work items, the allocator may store 708 in the child ID of the second work item the first ID of the first work item. As discussed above, this means for this illustrated embodiment the first work item cannot be deemed complete until the child work item is complete. A project cannot complete without work being performed to complete the project tasks. As illustrated, a resource (tool, person, machine, data access/data input, AI input or interaction, etc.) may be associated 710 with the first work item to \perform the first work item. Similarly, a resource may be associated 712 with the second work item to perform the second work item. As discussed above, a calendar may track work items and when they are expected to be performed. In the illustrated embodiment, a calendar is populated 714 with at least the timing characteristics of the work items. Once the calendar is populated, it may be reviewed (e.g., automatically though Artificial Intelligence analysis, application of machine logic, use of spreadsheet formulas, manual review by a person, etc.) to identify 716 one or more gaps in the calendar. It will be appreciated a gap represents a unit of time having a size, e.g., 1 day, etc.

The allocator tool data content may be adjusted 718 by, for example, rearranging resources assigned to the first and second work items, reordering when work items are performed, applying more resources to the project, breaking a work item into sub-items to be worked independently (where parallelization is possible). Thus, in various implementations, work items may have an associated Work ID, a status, include cross-reference to child tasks or work items to be complete before a work item may be complete, a status of the children to whom the work item is assigned, and a sequence associated with a work item to indicate in which order a resource (tool, person, machine, etc.) is going to work on the work items, and an expectation of how long it will take to do each work item. In a calendar component of various ones of the illustrated allocator tools (see, e.g., the right portion 102 of FIG. 1), the calendar increments daily into the future. Calendar cells (assuming the spreadsheet implementation) may contain formulas to implement the logic described herein, e.g., to decide whether or not on that date for that work item a resource will be working on a task.

As discussed above, when cells cross-reference task dependencies, there may be idle time. As discussed, e.g., with respect to FIGS. 5, gaps may be identified 716 and task order and selected assignee may be adjusted 718, e.g., rearranged, reassigned, etc., to close gaps. Performance characteristics of resources, such as unavailability of a resource (broken tool, person on vacation or quit without notice), may be tracked and also used to automatically update an allocator tool. It will be appreciated Artificial Intelligence tools may review multiple allocator tools to reassess and reassign tasks to maximize efficiency across multiple projects.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

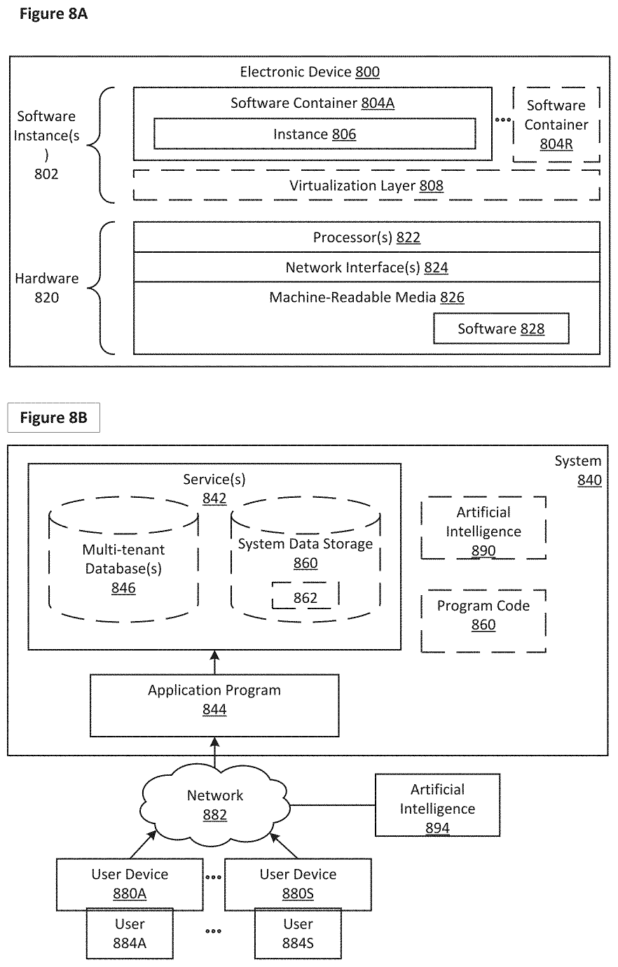

FIG. 8A is a block diagram illustrating an electronic device 800 according to some example implementations. FIG. 8A includes hardware 820 comprising a set of one or more processor(s) 822, a set of one or more network interfaces 824 (wireless and/or wired), and machine-readable media 826 having stored therein software 828 (which includes instructions executable by the set of one or more processor(s) 822). The machine-readable media 826 may include non-transitory and/or transitory machine-readable media. Each of the previously described operations for implementing a resource allocator tool and updating it manually or with an Artificial Intelligence (AI) program or service (see FIG. 8B item 890), e.g., such as describe above for manipulating a resource allocator tool, may be implemented in one or more electronic devices 800. In various implementations a resource allocator tool may be implemented and/or be distributed across one or more client and/or server device or machine (e.g., devices 800), where the software 828 represents the software to implement the allocator tool and to interface, if applicable, directly and/or indirectly with an AI to assist with and/or to manage the resource allocator. It will be appreciated software 828 may represent an application program, a web browser, a native client, a portal, a command-line interface, and/or an application programming interface (API) based upon protocols such as Simple Object Access Protocol (SOAP), Representational State Transfer (REST), etc. An AI service may be implemented in a separate set of one or more of the electronic devices 800 (e.g., a set of one or more server devices where the software 828 represents the software to implement the AI service), where in operation, the electronic devices implementing the clients and the AI service would be communicatively coupled (e.g., by a network) and would establish between them (or through one or more other layers and/or or other services) connections for managing and/or exchanging data and/or updating the resource allocator. Other configurations of electronic devices may be used in other implementations (e.g., an implementation in which the client and the AI service are implemented on a single one of electronic device 800).

During operation, an instance of the software 828 (illustrated as instance 806 and referred to as a software instance; and in the more specific case of an application, as an application instance) is executed. In electronic devices that use compute virtualization, the set of one or more processor(s) 822 typically execute software to instantiate a virtualization layer 808 and one or more software container(s) 804A-804R (e.g., with operating system-level virtualization, the virtualization layer 808 may represent a container engine (such as Docker Engine by Docker, Inc. or rkt in Container Linux by Red Hat, Inc.) running on top of (or integrated into) an operating system, and it allows for the creation of multiple software containers 804A-804R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-804R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 828 is executed within the software container 804A on the virtualization layer 808. In electronic devices where compute virtualization is not used, the instance 806 on top of a host operating system is executed on the “bare metal” electronic device 800. The instantiation of the instance 806, as well as the virtualization layer 808 and software containers 804A-804R if implemented, are collectively referred to as software instance(s) 802.

Alternative implementations of an electronic device may have numerous variations from that described above. For example, customized hardware and/or accelerators might also be used in an electronic device.

### Example Environment

FIG. 8B is a block diagram of a deployment environment according to some example implementations. A system 840 includes hardware (e.g., a set of one or more server devices) and software to provide service(s) 842, including the artificial intelligence (AI) support service for a resource allocator tool. In some implementations, the system 840 is in one or more datacenter(s). These datacenter(s) may be: 1) first party datacenter(s), which are datacenter(s) owned and/or operated by the same entity that provides and/or operates some or all of the software that provides the service(s) 842; and/or 2) third-party datacenter(s), which are datacenter(s) owned and/or operated by one or more different entities than the entity that provides the service(s) 842 (e.g., the different entities may host some or all of the software provided and/or operated by the entity that provides the service(s) 842). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 840 is coupled to user devices 880A-880S over a network 882. The service(s) 842 may be on-demand services that are made available to one or more of the users 884A-884S working for one or more entities other than the entity which owns and/or operates the on-demand services (those users sometimes referred to as outside users) so that those entities need not be concerned with building and/or maintaining a system, but instead may make use of the service(s) 842 when needed (e.g., when needed by the users 884A-884S). The service(s) 842 may communicate with each other and/or with one or more of the user devices 880A-880S via one or more APIs (e.g., a REST API). In some implementations, the user devices 880A-880S are operated by users 884A-884S, and each may be operated as a client device and/or a server device. In some implementations, one or more of the user devices 880A-880S are separate ones of the electronic device 800 or include one or more features of the electronic device 800. In some implementations user devices 880A-880S may operate as FIG. 1 items 104-108, and users 884A-884S correspond to users of items 104-108.

In some implementations, the system 840 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a relationship management system or service, a tenant may be a vendor using the relationship manager system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 840 is a multi-tenant cloud computing architecture supporting multiple services, such as one or more of the following types of services: Artificial intelligence (AI) multiparty engagement/conference support service; Dynamically updating service to update user interfaces based on the AI service; Relationship management; Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 840 may include an application platform 844 that enables PAAS for creating, managing, and executing one or more applications developed by the provider of the application platform 844, users accessing the system 840 via one or more of user devices 880A-880S, or third-party application developers accessing the system 840 via one or more of user devices 880A-880S.

In some implementations, one or more of the service(s) 842 may use one or more multi-tenant databases 846, as well as system data storage 880 for system data 882 accessible to system 840. In certain implementations, the system 840 includes a set of one or more servers that are running on server electronic devices and that are configured to handle requests for any authorized user associated with any tenant (there is no server affinity for a user and/or tenant to a specific server). The user devices 880A-880S communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the multi-tenant database(s) 846 and/or system data storage 880.

In some implementations, the service(s) 842 are implemented using virtual applications dynamically created at run time responsive to queries from the user devices 880A-880S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 860 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 844 includes an application setup mechanism that supports application developers' creation and management of applications, which may be saved as metadata by save routines. Invocations to such applications, including the resource allocator tool and artificial intelligence (AI) support service for the allocator tool, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (8G), and/or similar wired and/or wireless protocols, and may include one or more intermediary devices for routing data between the system 840 and the user devices 880A-880S.

Each user device 880A-880S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 840. For example, the user interface device can be used to access data and applications hosted by system 840, and to perform searches on stored data, and otherwise allow one or more of users 884A-884S to interact with various GUI pages that may be presented to the one or more of users 884A-884S. User devices 880A-880S might communicate with system 840 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 880A-880S might include an HTTP client, commonly referred to as a “browser,” for sending and receiving HTTP messages to and from server(s) of system 840, thus allowing users 884A-884S of the user devices 880A-880S to access, process and view information, pages and applications available to it from system 840 over network 882.

The system 840 may include an Artificial Intelligence (AI) 890 engines (or “machine intelligence”) to assist with analysis and reconfiguration of an allocator tool. It will be appreciated there are many different AI Engines that may be employed, such as neural networks (feedforward, recurrent, backpropagation, deep learning, etc.), expert systems, and many other analytical systems. It will be appreciated an AI engine 890 may be incorporated into the system 840 as illustrated. However, since a robust AI Engine may require resources unavailable to some computers or machines, an AI engine may be available as a remote AI engine resource 892 accessible over the network 882 and/or other network(s) such as the Internet. It will be appreciated one or more AI engines may cooperatively operate to analyze problems with an allocator tool configuration, and automatically reconfigure the allocator tool's content (e.g., reassign and/or reorganize tasks) to minimize gaps as discussed above.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations. The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.). While the above description includes several example implementations assuming for expository convenience use of an application program, browser and/or standalone software to implement a resource allocator tool in a spreadsheet and/or interact with all or selected aspects of the artificial intelligence (AI) support service for the resource allocator tool, the invention is not limited to the implementations and interactions described and can be practiced with modification and alteration within the spirit and scope of the appended claims. The description is thus illustrative instead of limiting.

What is claimed is:

1. A method to enable a computer system to automatically allocate resources, comprising:
storing data corresponding to a project having associated work items, in which work items have associated therewith an ID to uniquely identify the associated work item, a child ID to cross-reference to a different work item, a resource to perform the work item, and a story points metric to estimate time to complete the work item;
receiving first data corresponding to a first work item, the first data including a first ID, and a first story points metric;
receiving second data corresponding to a second work item, the second data including a second ID, and a second story points metric;
storing in the child ID of the second work item the first ID of the first work item;
associating a first resource to perform the first work item;
associated a second resource to perform the second work item;
determining a correspondence between the first and second work items and a calendar;
identified one or more gaps in the calendar, the one or more gaps having a size; and
reducing the size of the one or more gaps based at least in part on rearranging resources assigned to the first and second work items.

2. The method of claim 1, wherein an Artificial Intelligence (AI) at least identifies the one or more gaps in the calendar and performs the rearrangement of resources in the resource allocation tool.

3. The method of claim 2, wherein the AI and the resource allocation tool are disposed within the same computing device.

4. The method of claim 1, wherein resources have associated constraint data identifying one or more restriction to performing one or more work item.

5. The method of claim 4, further comprising:
determining an estimate delivery date based at least in part on the correspondence between the first work item, the second work item, the calendar, and the constraint data.

6. The method claim 1, further comprising:
determining an estimated delivery date based at least in part on the correspondence between the first work item, the second work item, and the calendar;
wherein the rearrangement of resources decreases the estimated delivery date.

7. The method of claim 1, wherein the indicator the second work item is a child task of the first work item requires the second work item to complete before the first item can complete.

8. The method of claim 1, further comprising:
incorporating a buffer into a calculation of the story points metric to allow for a slippage in performance of the work item.

9. The method of claim 1, further comprising:
identifying a risky work item; and
prioritizing a performance of the risky work item ahead of another work item.

10. A non-transitory machine-readable storage medium that provides instructions for a computer system to provide a resource allocation tool, the instructions, if executed by a processor, are configurable to cause the processor to perform operations comprising:
store data corresponding to a project having associated work items, in which work items have associated therewith an ID to uniquely identify the associated work item, a child ID to cross-reference to a different work item, a resource to perform the work item, and a story points metric to estimate time to complete the work item;
receive first data corresponding to a first work item, the first data including a first ID, and a first story points metric;
receive second data corresponding to a second work item, the second data including a second ID, and a second story points metric;
store in the child ID of the second work item the first ID of the first work item;
associate a first resource to perform the first work item;
associate a second resource to perform the second work item;
determine a correspondence between the first and second work items and a calendar;
identify one or more gaps in the calendar, the one or more gaps having a size; and
reduce the size of the one or more gaps based at least in part on rearranging resources assigned to the first and second work items.

11. The storage medium of claim 10 to further provide instructions for accessing an Artificial Intelligence (AI), which if executed by the processor, are configurable to cause the processor to further perform operations comprising:
identify the one or more gaps in the calendar; and
perform the rearrangement of resources in the resource allocation tool.

12. The storage medium of claim 11 to further provide instructions, which if executed by the processor, are configurable to cause the processor to further perform operations comprising:
remotely access the AI;
provide at least a portion of the data corresponding to a project to the AI;
instruct the AI to perform the identify one or more gaps in the calendar; and
receive an update to the allocation tool from the AI.

13. The storage medium of claim 10, wherein resources have associated constraint data to identify one or more restriction to the perform one or more work item.

14. The storage medium of claim 10 to further provide instructions, which if executed by the processor, are configurable to cause the processor to further perform operations comprising:
determine an estimate delivery date based at least in part on the correspondence between the first work item, the second work item, the calendar, and the constraint data.

15. The storage medium of claim 10 to further provide instructions, which if executed by the processor, are configurable to cause the processor to further perform operations comprising:
determine an estimated delivery date based at least in part on the correspondence between the first work item, the second work item, and the calendar;
wherein the rearrangement of resources decreases the estimated delivery date.

16. The storage medium of claim 10, wherein the indicator the second work item is a child task of the first work item requires the second work item to complete before the first item can complete.

17. The storage medium of claim 10 to further provide instructions, which if executed by the processor, are configurable to cause the processor to further perform operations comprising:
incorporate a buffer into a calculation of the story points metric to allow for a slippage in performance of the work item.

18. The storage medium of claim 10 to further provide instructions, which if executed by the processor, are configurable to cause the processor to further perform operations comprising:
identify a risky work item; and
prioritize a performance of the risky work item ahead of another work item.
